(19) United States
(12) Patent Application Publication
(10) Pub. No.: US 2021/0353484 A1
(43) Pub. Date: Nov. 18, 2021

(54) NEGATIVE PRESSURE PROTECTION SYSTEM

(71) Applicant: GrowTrend Biomedical Co., Ltd., Hsinchu City (TW)

(72) Inventors: Ching-Liang YU, Taoyuan City (TW); Pei-Yin OU, New Taipei City (TW); Yun-Yueh LIU, Miaoli City (TW); Neng Yu PAN, New Taipei City (TW)

(73) Assignee: GrowTrend Biomedical Co., Ltd., Hsinchu City (TW)

(21) Appl. No.: 17/110,769

(22) Filed: Dec. 3, 2020

(30) Foreign Application Priority Data
May 13, 2020 (TW) 109205832

(51) Int. Cl. A61G 10/02; F24F 3/167

(52) U.S. Cl. CPC A61G 10/02; F24F 2011/0005; A61G 2200/32; F24F 3/167

(57) ABSTRACT

A negative pressure protection system has a cover enclosing an inner space, a ventilation duct fluidly communicating with an air outlet port of the cover, a filter having an inlet end communicating with the ventilation duct, and an air exhausting device connected to an outlet end of the filter. The air exhausting device draws air out from the inner space of the cover via the ventilation duct. The air is filtered and purified by the filter and then is exhausted away by the exhausting device.

### CROSS-REFERENCE TO RELATED APPLICATIONS

This application is based upon and claims priority under 35 U.S.C. 119 from Taiwan Patent Application No. 109205832 filed on May 13, 2020, which is hereby specifically incorporated herein by this reference thereto.

### BACKGROUND OF THE INVENTION

### 1. Field of the Invention

The present invention relates to a protection system, especially to a negative pressure protection system that has a half-cover.

### 2. Description of the Prior Art(s)

Nowadays, protective isolation equipment in medical institutions may be negative pressure isolation wards or protective masks. With reference to FIG. 3, a conventional negative pressure isolation ward 90 is a room installed with an independent air conditioner 91. The air conditioner 91 draws out internal air from the conventional negative pressure isolation ward 90, filters the internal air through a filter, and exhausts the internal air through an air duct. External air flows into the conventional negative pressure isolation ward 90 through door slits 92 or air inlet ports 93 on the ceiling. Thus, respiratory droplets 94, which contain pathogenic bacteria, from patients do not spread to other rooms by air.

However, since the conventional negative pressure isolation ward 90 is disposed inside a building, a range of activities of a patient is limited to the conventional negative pressure isolation ward 90. Moreover, the conventional negative pressure isolation ward 90 is normally set up by redecorating an existing ward, such that airflow field inside the conventional negative pressure isolation ward 90 is usually of poor design. For instance, when the external air flows into the conventional negative pressure isolation ward 90, the external air would flow along the ceiling or a shortest path and be exhausted by the air conditioner 91 directly, causing ineffective exhausting. Consequently, the respiratory droplets 94 from the patient on a hospital bed are unable to be taken away by airflow and would be accumulated around the hospital bed.

The protective mask is worn on a head of a wearer and has a front cover lens sheltering a face of the wearer. The protective mask is easy to wear because of its simple structure and allows the wearer to move freely. However, since there are still gaps between the protective mask and the head or the face of the wearer, the protective mask is only suitable for patients without infectious respiratory diseases or relevant medical staffs to wear, and is not suitable for patients having infectious respiratory diseases to wear.

In addition, if an isolation protective shield is installed around the patient, pathogenic bacteria expelled as the patient cough or exhale would be spread with airflow around the patient, such that risk of infection among people therearound is increased. Moreover, the isolation protective shield covers the patient with its rigid structure. When the patient needs to be treated with a respirator, arrangement for pipelines of the respirator would be hindered by the isolation protective shield. Furthermore, if the pipelines are bent, airflow in the pipelines as well as therapeutic effectiveness of the respirator are affected.

To overcome the shortcomings, the present invention provides a negative pressure protection system to mitigate or obviate the aforementioned problems.

### SUMMARY OF THE INVENTION

The main objective of the present invention is to provide a negative pressure protection system that has a cover, a ventilation duct, a filter, and an air exhausting device. The cover encloses an inner space and has an air inlet port and an air outlet port. A first end of the ventilation duct is connected to the cover and fluidly communicates with the air outlet port. The filter has an inlet end and an outlet end. The inlet end of the filter is connected to and fluidly communicates with a second end of the ventilation duct. The air exhausting device is connected to the outlet end of the filter. The air exhausting device draws air out from the inner space of the cover via the ventilation duct, and the air flows through the filter and is exhausted away by the exhausting device.

A head of a patient having infectious respiratory diseases is disposed in the inner space of the cover. When the air exhausting device is started, the air and droplets from the patient are exhausted through the connecting tube, the ventilation duct, and the filter in a unidirectional flow and are filtered and purified by the filter. Then the filtered and purified air is exhausted by the air exhausting device. Accordingly, effects of isolating the patient and purifying the air can be achieved.

Other objectives, advantages and novel features of the invention will become more apparent from the following detailed description when taken in conjunction with the accompanying drawings.

### BRIEF DESCRIPTION OF THE DRAWINGS

FIG. 1 is perspective view of a negative pressure protection system in accordance with the present invention;

FIG. 2 is an operational side view of the negative pressure protection system in FIG. 1; and

FIG. 3 is a side view of a conventional negative pressure isolation ward in accordance with the prior art.

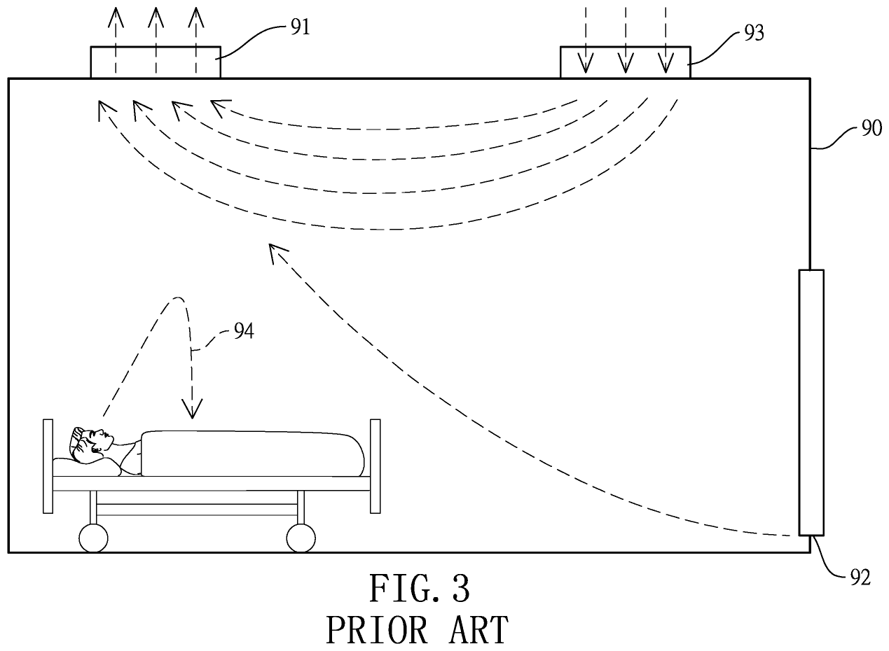

### DETAILED DESCRIPTION OF THE PREFERRED EMBODIMENTS

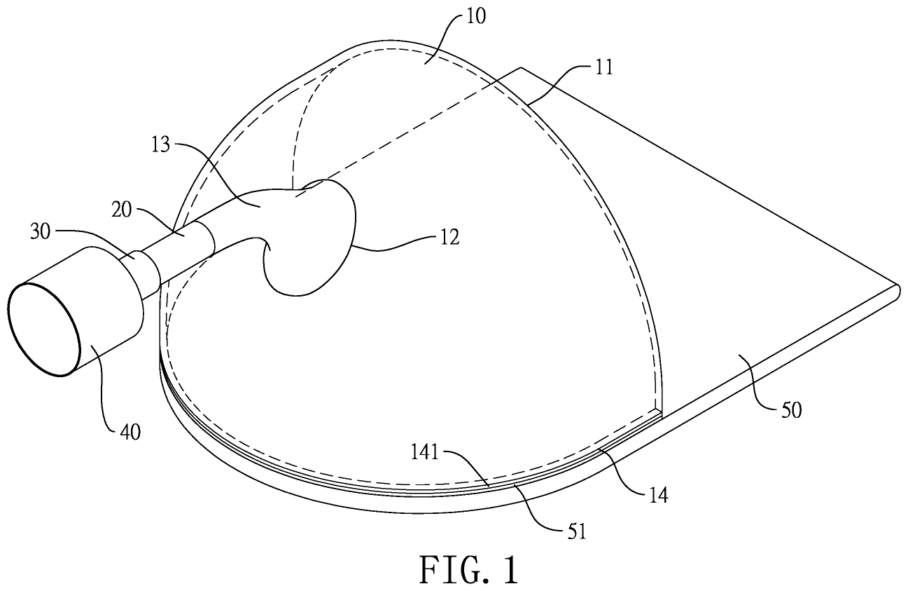

With reference to FIG. 1, a negative pressure protection system in accordance with the present invention comprises a cover 10, a ventilation duct 20, a filter 30, an air exhausting device 40, and a bottom mat 50.

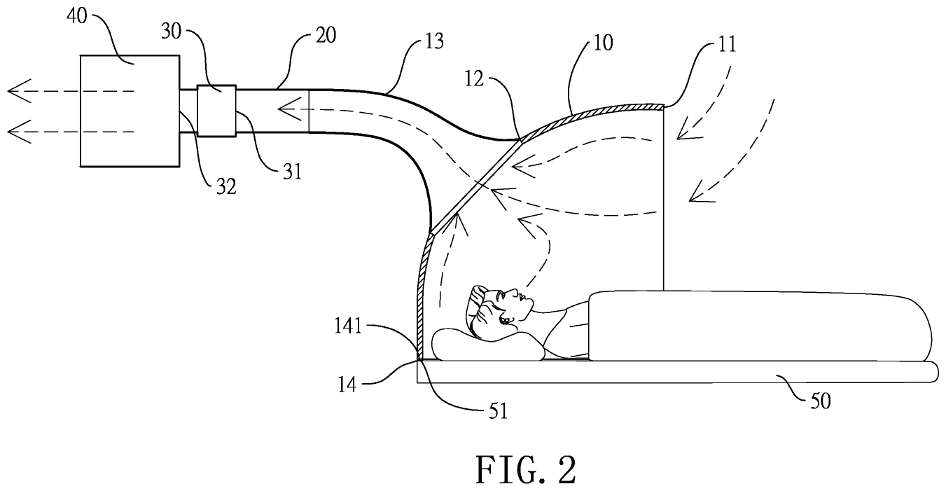

With reference to FIGS. 1 and 2, the cover 10 encloses an inner space and has an air inlet port 11 and an air outlet port 12. The air inlet port 11 and the air outlet port 12 are separately defined through the cover 10.

In the preferred embodiment, the cover 10 is made of hard material, is substantially quarter-spherical, and has a bottom edge 14. The air inlet port 11 and the air outlet port 12 are oppositely disposed on the cover 10, and the air outlet port 12 is substantially disposed at a center of the cover 10. Moreover, an area of the air inlet port 11 is larger than an area of the air outlet port 12. A connecting tube 13 is securely attached to an outer surface of the cover 10 and fluidly communicates with the air outlet port 12. The connecting tube 13 has a proximal end securely attached to the cover 10 and a distal end. The connecting tube 13 tapers from the proximal end to the distal end. The connecting tube 13 and the cover 10 may be integrally formed as a single part. The bottom edge 14 of the cover 10 may be attached to any plane. However, a shape of the cover 10 is not limited to the shape as described above. The shape of the cover 10 may vary according to user's needs as long as the cover 10 is able to cover over a patient's head. For instance, the cover 10 may be cuboid, as long as the cover 10 is able to cover an upper body of a human body, especially the head of the human body. Moreover, a shelter, such as a shading fabric, may be mounted on the air inlet port 11 of the cover 10, so as to provide privacy to the patient.

The ventilation duct 20 is tubular and has a first end and a second end. The first end of the ventilation duct 20 is connected to the distal end of the connecting tube 13, such that the first end of the ventilation duct 20 is connected to the cover 10 via the connecting tube 13 and fluidly communicates with the air outlet port 12. The ventilation duct 20 guides air out from the inner space of the cover 10 through the air outlet port 12 and the connecting tube 13.

The filter 30 has an inlet end 31 and an outlet end 32. The inlet end 31 of the filter 30 is connected to and fluidly communicates with the second end of the ventilation duct 20. In the preferred embodiment, the filter 30 is able to filter and purify pathogenic bacteria in the air. Therefore, when the air with pathogenic bacteria enters the filter 30 from the inlet end 31, the air that exits the filter 30 from the outlet end 32 would have been filtered and purified. Since the filter 30 is a conventional assembly, detailed description of the structure of the filter 30 is omitted.

The air exhausting device 40 is connected to the outlet end 32 of the filter 30. Since the air exhausting device 40 is a conventional assembly, detailed description of the structure of the air exhausting device 40 is omitted. The exhausting device 40 draws the air out from the inner space of the cover 10 via the ventilation duct 20, and the air flows through the filter 30 and is exhausted away by the exhausting device 40. Thus, the air can be filtered before being exhausted.

The bottom mat 50 is made of soft material and may be any kind of soft cushion. In the preferred embodiment, the bottom mat 50 includes, but not limited to, material with silicon. Preferably, the bottom mat 50 has a size that fits human bodies. A side of the bottom mat 50 is sealingly and detachably mounted to the cover 10 at where the air inlet port 11 is disposed. Specifically, a width of the cover 10 is smaller than or equal to a width of the bottom mat 50 and is greater than an average shoulder width of the human bodies.

Specifically, the bottom edge 14 of the cover 10 is provided with a first connecting portion 141 and an end edge of the bottom 50 is provided with a second connecting portion 51. The first connecting portion 141 and the second connecting portion 51 are detachably connected with each other.

In the preferred embodiment, the first connecting portion 141 and the second connecting portion 51 are, but not limited to, snap fasteners. In other embodiments, the first connecting portion 141 and the second connecting portion 51 may be clip buckles, hook and loop fasteners, or other fasteners that can sealingly and detachably connect the cover 10 with the bottom mat 50.

With reference to FIG. 2, when using the negative pressure protection system of the present invention, the bottom edge 14 of the cover 10 is assembled to the bottom mat 50, the first end of the ventilation duct 20 is connected to the connecting tube 13 of the cover 10, the second end of the ventilation duct 20 is connected to the inlet end 31 of the filter 30, and the air exhausting device 40 is connected to the outlet end 32 of the filter 30.

The patient having infectious respiratory diseases lies on the bottom mat 50 with his/her head disposed in the inner space of the cover 10. When the air exhausting device 40 is started, air pressure inside the inner space of the cover 10 is lower than normal atmospheric pressure, such that the air and droplets from the patient are exhausted through the connecting tube 13, the ventilation duct 20, and the filter 30 in a unidirectional flow and are filtered and purified by the filter 30. Afterwards, the filtered and purified air is exhausted by the air exhausting device 40. Accordingly, effects of isolating the patient and purifying the air can be achieved.

Since the bottom mat 50 is made of soft material and the cover 10 is made of hard material, the cover 10 is able to be sealingly mounted to the bottom mat 50, so as to avoid leaking of the pathogenic bacteria. Furthermore, during operation, the air exhausting device 40 forms the unidirectional flow in the cover 10 to steadily drive the air and the droplets to flow toward the air outlet port 12. Accordingly, noises can be reduced.

Moreover, since the cover 10 and the patient keep a certain distance, the patient would not feel oppressed or the inner space of the cover 10 hot and stuffy. In addition, as the cover 10 is detachable from the bottom mat 50, it is convenient for the patient to get up and leave the negative pressure protection system, and the cover 10 and the bottom mat 50 can be cleaned individually. Accordingly, the negative pressure protection system is comfortable and safe for use.

Furthermore, in the preferred embodiment, the cover 10 has one air outlet port 12 as described above. Otherwise, the cover may have more than one air outlet ports. Accordingly, the negative pressure protection system may comprise multiple filter and multiple air exhausting devices. Thus, the air and the droplets from the patient can be exhausted quickly and efficiently.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A negative pressure protection system comprising:
a cover enclosing an inner space and having an air inlet port and an air outlet port;
a ventilation duct having a first end and a second end, and the first end of the ventilation duct connected to the cover and fluidly communicating with the air outlet port;
a filter having
an inlet end connected to and fluidly communicating with the second end of the ventilation duct; and
an outlet end; and
an air exhausting device connected to the outlet end of the filter, wherein the air exhausting device draws air out from the inner space of the cover via the ventilation duct, and the air flows through the filter and is exhausted away by the exhausting device.

2. The negative pressure protection system as claimed in claim 1 further comprising a bottom mat, and a side of the bottom mat detachably mounted to the cover at where the air inlet port is disposed.

3. The negative pressure protection system as claimed in claim 2, wherein
the bottom edge of the cover is provided with a first connecting portion; and
an end edge of the bottom is provided with a second connecting portion, and the second connecting portion is detachably connected with the first connecting portion.

4. The negative pressure protection system as claimed in claim 3, wherein the first connecting portion and the second connecting portion are snap fasteners.

5. The negative pressure protection system as claimed in claim 4, wherein the bottom mat includes material with silicone.

6. The negative pressure protection system as claimed in claim 1, wherein
the cover is quarter-spherical;
a connecting tube is securely attached to an outer surface of the cover and fluidly communicates with the air outlet port; and
the ventilation duct is connected to the cover via the connecting tube.

7. The negative pressure protection system as claimed in claim 2, wherein
the cover is quarter-spherical;
a connecting tube is securely attached to an outer surface of the cover and fluidly communicates with the air outlet port; and
the ventilation duct is connected to the cover via the connecting tube.

8. The negative pressure protection system as claimed in claim 3, wherein
the cover is quarter-spherical;
a connecting tube is securely attached to an outer surface of the cover and fluidly communicates with the air outlet port; and
the ventilation duct is connected to the cover via the connecting tube.

9. The negative pressure protection system as claimed in claim 4, wherein
the cover is quarter-spherical;
a connecting tube is securely attached to an outer surface of the cover and fluidly communicates with the air outlet port; and
the ventilation duct is connected to the cover via the connecting tube.

10. The negative pressure protection system as claimed in claim 5, wherein
the cover is quarter-spherical;
a connecting tube is securely attached to an outer surface of the cover and fluidly communicates with the air outlet port; and
the ventilation duct is connected to the cover via the connecting tube.

11. The negative pressure protection system as claimed in claim 6, wherein the connecting tube has
a proximal end securely attached to the cover; and
a distal end connected to the first end of the ventilation duct;
wherein the connecting tube tapers from the proximal end to the distal end.

12. The negative pressure protection system as claimed in claim 7, wherein the connecting tube has
a proximal end securely attached to the cover; and
a distal end connected to the first end of the ventilation duct;
wherein the connecting tube tapers from the proximal end to the distal end.

13. The negative pressure protection system as claimed in claim 8, wherein the connecting tube has
a proximal end securely attached to the cover; and
a distal end connected to the first end of the ventilation duct;
wherein the connecting tube tapers from the proximal end to the distal end.

14. The negative pressure protection system as claimed in claim 9, wherein the connecting tube has
a proximal end securely attached to the cover; and
a distal end connected to the first end of the ventilation duct;
wherein the connecting tube tapers from the proximal end to the distal end.

15. The negative pressure protection system as claimed in claim 10, wherein the connecting tube has
a proximal end securely attached to the cover; and
a distal end connected to the first end of the ventilation duct;
wherein the connecting tube tapers from the proximal end to the distal end.
